(19) United States
(12) Patent Application Publication
(10) Pub. No.: US 2004/0133863 A1
(43) Pub. Date: Jul. 8, 2004

(54) Design methods and apparatuses of photodiodes with adaptive structure to achieve smooth and wavelength-selective photo-responses

(75) Inventors: Li-Kuo Dai, Hsinchu (TW); Ping-Kuo Weng, Bade City (TW); Far-Wen Jih, Taoyuan (TW); Kaung-Hsin Huang, Hsinchu (TW); Wei-Jean Liu, Changhua (TW); Oscal Tzyh-Chiang Chen, Chiayi (TW)

Correspondence Address: APEX JURIS, PLLC, 13194 EDGEWATER LANE NORTHEAST, SEATTLE, WA, 98125, US

(73) Assignee: Chung-Shan Institute of Science and Technology, Taoyuan County (TW)

(21) Appl. No.: 10/672,748

(22) Filed: Sep. 27, 2003

(30) Foreign Application Priority Data
Dec. 12, 2002 (TW) 91135904

(51) Int. Cl. G06F 9/45; G06F 17/50

(52) U.S. Cl. 716/5

(57) ABSTRACT

The design methods and apparatuses of photodiodes with adaptive structures to achieve smooth and wavelength-selective responses are proposed. By using the adequate sizes of the photo-sensing areas and gains of the back-end amplifiers towards the different photo-responses of multiple photodiodes, the photo-responses from these photodiodes are summed together to yield the uniform distribution of the total photo-responses. Based on the physical characteristics of the process parameters, the equation of the photo-responses for the PN junction is derived to find the optimized values of the process parameters for increasing the photo-response and achieving the peak value of the photo-responses at a specific wavelength. The photodiode with multiple PN junctions and multiple switches is designed to achieve multiple photo-responses in a single photodiode. By using the switches to turn off the unused PN junctions, the selected PN junctions can generate the required photo-responses. Hence, this kind of the photodiode can sense multiple colors without using color filters.

### BACKGROUND OF THE INVENTION

1. Field of the Invention

This invention relates to adaptive photodiode structures, of which design methods and apparatuses aiming at smoothing the photo-response and making the photo-response having a peak value at a specific wavelength, that are realized by the photodiodes with color-selective mechanisms under the condition of without extra color filters.

2. Description of the Prior Art

As the progress of the photo-electronic technology and the development of the internet, the products of imaging applications are welcome in the market where the image sensors are the devices of capturing the images such as the digital camera, scanner, PC camera, and video camera. It is obvious that the image sensors play an important role in modem lives. However, during the manufacture process of the image sensor, it is possible for us to fabricate the photodiodes with sensing different colors such as red, green and blue only by means of color filters. Since each photodiode only senses a specific color, the back-end image processing mechanism is used to restore the original color image. However, on one hand the existence of color filters causes the decrease of the photo-responses of the photodiodes whereas on the other hand it also makes the fabrication process more complex and thus increases the fabrication cost.

The image sensor could be subdivided into two parts of the front-end photodiode array and the back-end signal processing circuit where its architecture could be illustrated as shown in FIG. 1. Each photodiode is connected to an amplifier, which transfers the captured image signal into the electrical signal. Additionally, the overall photodiode array is arranged by using the red, green and blue photodiodes as shown in the FIG. 1 according to the perceptual principle of human vision. As for the signal processing part, it comprises the decoder, timing-control unit, compensating and synthesizing circuit, etc. From the FIG. 1, it could be seen that the photodiode plays the transformation from photon to electron, and this invention proceeds innovative design aiming at the photodiodes of the image sensor.

The conventional color photodiode is shown in FIG. 2, which is to add a layer of material with a light-filtration effect upon each photodiode as well as the general standard process to yield each color. Such fabrication method makes the photodiode having a large response toward a specific wavelength and lessening the responses of the unwanted wavelengths, of which operation is to filter out the unwanted wavelengths of the incident light. Let's take the common-used red, green and blue filters as an example, their color photodiodes showing the photo-responses as shown in FIG. 3. However, such fabrication method has the following drawbacks.

(1) The fabrication process requires the extra steps in addition to the original standard process. That is to say, the extra several masks are required when the color filters are added on top of the common-used standard fabrication process, which increase the manufacture cost.

(2) Most of the incident light is absorbed and reflected during the process of passing through the color filter which decreases the photo-response of the photodiode as well as makes inferior influence upon the characteristics of the devices. Hence, one extra process of micro lens is included for the commonly-used color filter to focus incident light with the purpose of increasing the induced current.

(3) In order to meet the requirement of sensing different colors, the process must provide different color filters which increase the degree of difficulty on fabrication process. To integrated with the micro lens, the fabrication process should be modified in extra when there is a larger degree of alteration for the sensing area of a photodiode that yields a better response under a specific curvature radius of the lens.

In fact, despite of the above-mentioned three drawbacks, since each photo-sensitive material of a photodiode has non-uniform responses toward different wavelengths of incident light, the color filter should be designed by taking into consideration the photo-sensitive characteristics of the material itself. On the other hand, the back-end color compensation circuit is developed with considering the characteristics of the color filter, mainly the transmission rate of incidence light, which makes the overall design more complicated.

From the above-mentioned, it is understood that there still are many drawbacks in the conventional fabrication process which needs to be improved.

The inventors of this invention, due to understanding each drawback derived from the conventional color photodiodes, tried to improve it by studying hard for many years, and finally they successfully accomplished the research of the photodiodes with adaptive structures to achieve smooth and wavelength-selective photo-responses of this invention.

Field of the Invention:

To sum up, the above-mentioned describes some drawbacks of currently-used color image sensors which are required to be improved where this invention provides the method and apparatus of improving them by the following ways.

(1) To make the compensation design toward each photodiode to have the smooth photo-response in the visible-wavelength by adapting the size of the photodiode area and the gain of the photodiode amplifier, the design of the back-end color compensation circuit could be simplified.

(2) The design method of the optimized photodiodes is developed by effectively utilizing some physical characteristics of the process parameters comprising how to acquire the maximum photo-response at a specific wavelength.

(3) In prospect of the process technology, this invention provides the way of utilizing the multiple PN junctions to design the adaptive photodiodes. By utilizing such approach, the different photo-responses within an adaptive photodiode could be obtained when this photodiode is implemented by an adequate layout.

The above-mentioned three ways improve the drawbacks mentioned before. The first one improves the issue of non-uniform photo-responses at different wavelengths, that can be beneficial to the simplification of the back-end color compensation circuit, whereas the second and third ones are to overcome the drawbacks brought by the color filters of which function is replaced by the adaptive photodiode with a wavelength-selective photo-response.

Detailed Description of this Invention:

First it is illustrated that this invention derives the photodiode model as well as explores the influence of physical parameters of the photodiode toward the photo-response. Next to design the photodiode by utilizing the phenomena discovered from the physical parameters, the color photodiodes can be accomplished without color filters under the standard fabrication process. Finally, the photodiodes of this invention are realized through several chips fabricated by TSMC (Taiwan Semiconductor Manufactory Company).

1. Introduction to the Basic Principle of this Invention:

Before presenting the design methods and apparatuses of this invention, first it is simply illustrated toward the basic principle of this invention: the principle derivation and model simulation of the photo-response of the photodiode.

The reason why the photo-current is produced comes from generating the electron-hole pair excited by the incident light, and next separating the electron-hole pair by using the voltage potential on both ends of the N-type and P-type semiconductors to yield the photo-current. The whole process is shown in FIG. 4. Here, there are two main sources for the production of the photo-currents: the first one comes from the diffusion current caused by the uniform distribution of the carrier concentration beyond the depletion region, and the second one comes from the electric field within the depletion region where the electric field separates the electron-hole pairs produced by induction to generate the drift current.

Next the photon flux, which is defined to be the number of the electron-hole pairs excited within the unit area under a specific incident light, is represented by φ₀ in the following equation,

$${ϕ}_{0} = \frac{{P}_{i n} ( 1 - R ( λ ) )}{Ahv} \qquad ( 2.1 )$$

where Pᵢₙ is the energy of the incident light, R(λ) represents the reflection rate of the incident light that is the function of wavelength, A is the light shading area, h represents the Planck constant, and v represents the frequency of the incident light which could be obtained by utilizing the velocity of light divided by its wavelength. The subscript symbol of φ₀ in the Eq.(2.1) represents the relationship between the photon flux with the distance from the lighted surface which is illustrated in FIG. 5. If φ₀ is the photon flux on the lighted surface, then the photon flux will be decayed exponentially along with the distance from the lighted surface. If φ_{X} represents the photon flux on distance x from the lighted surface, then φ_{X} could be represented as the following equation.

φ_{X}=®₀e^{-αx} (2.2)

The absorption coefficient α is an important parameter which is related to the material. Since each material has a different energy band and the energy carried by the photons is inversely proportional to the wavelength of these photons, the energy carried by the photons should be larger than the energy band of the material such that it could be absorbed by the material to yield the electron-hole pairs. The probability of the photons being aborted by the material conforms the Gaussian distribution. If the energy carried by the incident photons is larger, then the chance of the photons carrying high energy being absorbed at the position near the surface is larger. Otherwise, if it is smaller, the chance is also smaller, so that it will be absorbed on the deeper position which is far away from the surface of the material, to yield the electron-hole pairs. Because the energy of the photons is inversely proportional to their wavelength, the longer the wavelength of the incident light is, the deeper position the incident light is absorbed at. Additionally the shorter the wavelength is, the shallower position it is absorbed at. Hence another physical parameter should be mentioned here: the absorption length, by definition it being the reversal of the absorption coefficient 1/α, which means that at the fixed-wavelength incident light, its energy is decayed to 1/e of the original one after it passes through the distance of 1/α away from the lighted surface. The absorption length versus the wavelength of the incident light λ is depicted in FIG. 6. From FIG. 6, it is clearly discovered that the longer the wavelength of the incident light is, the longer its absorption length is. In other words, the incident light with a longer wavelength penetrates to a deeper position before absorption. According to the experimental result, the relationship between absorption coefficient α and the wavelength of the incident light λ, taking the silicon as the material, is formulated as below.

log₁₀α=13.2131−36.7985λ+48.1893λ²−22.7562λ³ (2.3)

According to the physical characteristics of the photodiode, the simulation of the photo-response is carried out by the following equations:

(1) the thermal equilibrium equation of minor carriers,

(2) the density equation of the photo current on both sides of the lighted material,

(3) the continuity of minor carrier density and current density at the homogeneous materials, and

(4) the concentration equilibrium equations on the boundary condition of the depletion region between the heterogeneous materials.

FIG. 7 illustrates the photodiode with the Nwell-Pepi-Psubstrate junction structure by using the 1P3M 0.5 um CMOS epitaxial wafer process provided by the TSMC, whereas FIG. 8 shows the comparison between the simulation and the measurement results toward said photodiode. From results of FIG. 8, the derived model is very promising to estimate the behavior of the photo-response of the photodiode.

2. The Derivation and Analysis of the Simple Model of this Invention:

After simulation and derivation of the photo-response model of the photodiode, the impact of each parameter toward the photo-response should be understood. After understanding the impact of these related parameters toward the photo-response, the required design task could be preceded by utilizing such characteristics of which two main parameters are ion implantation concentration and ion implantation depth.

The concentration of ion implantation affects the magnitude of the photo current since the photodiode is operated under the reverse bias voltage. The minor carriers are attracted by the electric field inside the depletion region, then they pass through the depletion region quickly, and thus they could form the photo currents efficiently. Hence, the larger the concentration of tion implantation is, the more chance the recombination of minor carriers on the path of drifting onto the depletion region has so that the number of minor carriers which forms the photo current relatively reduces. The whole process depicted in FIG. 9, the black spots in the upper part of the figure is the major carriers, which could be viewed as the concentration of ion implantation, and the white spots represent the minor carriers, whereas in the lower part the white spots could be viewed as the concentration of ion implantation, and the black spots represent the minor carrier. From FIG. 9, the number of ions being doped impacts upon the number of minor carriers reaching to the boundary edges of the depletion region. FIG. 10 illustrates the relationship between the ion implantation concentration and the mean lifetime of minor carriers. From FIG. 10, it could be clearly seen that the larger the concentration of ions being doped is, the shorter the mean lifetime of minor carrier is, and thus the smaller the induced photo-currents are.

The depth of ion implantation affects the photodiode to absorb the wavelengths of incident light. Referring to the above-mentioned absorption length and FIG. 6, it could be seen clearly that the light with a longer wavelength penetrates to the deeper junction, so the incident light with a longer wavelength can excite electron-hole pairs at the deeper region. However, to become photo-currents, the electron-hole pairs should reach to the boundary edges of the depletion region successfully such that they would be absorbed and transformed to the photo-currents. In other words, the photodiode has a greater response toward the incident light with a longer wavelength at the deeper region whereas for the shallower region it has a better response toward the incident light with a shorter wavelength.

FIG. 11 shows the simulation results of the currents contributed by the three regions of the photodiode as shown in FIG. 7. The depth of the junction formed by the Nwell region is shorter, so it has a larger response toward a shorter wavelength, wherein the peak value of the photo-response occurs at a shorter wavelength. The depth of the junction formed by the Psubstrate region is deeper, so the Psubstrate region has a better response toward the incident light with a longer wavelength, so the peak value appears in a longer wavelength. As for the magnitude of the photo-currents, since the doping concentration in the Psubstrate region is lower than that in the Nwell region, a larger amount of photo-currents from the Psubstrate region are induced. As well as the ion implantation concentration affects magnitude of the photo currents, another phenomena could be observed clearly: the current contributed by the Psubstrate region is obviously larger than those contributed by the other two regions. The reason is that the depth in the Psubstrate region is too long. Due to a long depth, a large amount of the photons are absorbed in the Psubstrate region, which makes the photo-response of the Psubstrate region being almost equal to the overall photo-response from the three regions. As for the magnitude of the current in the depletion region, it is determined by the width of the depletion region. In general, the width of the depletion region is within several micron meters, so there is little for the drift current generated from the depletion region.

Two ideas appear from my thought here. The first one is the method to compensate non-uniform distribution of the photo-responses of the photodiode at different wavelengths. When the photo-responses that used to have low values at some wavelengths are efficiently increased, and these photo-responses at different wavelengths are integrated, a curve with uniform distribution of the photo-responses at different wavelengths can be obtained. This method can be useful to simplify the design of the color compensation circuit. From this we also conclude some design principles of the manufacture process to achieve the optimized photodiode with uniform distribution of the photo-responses at different wavelengths. The second idea comes from the requirement of removing the color filters. From the previous simulation results, it could be seen that the overall photo-response is obtained by integrating the partial photo-responses at different wavelengths. Hence if we could find a method to independently obtain several partial photo-response, these photo-responses in one photodiode could individually show up under a control mechanism without using color filters.

### BRIEF DESCRIPTION OF THE DRAWINGS

The drawings disclose an illustrative embodiment of the present invention which serves to exemplify the various advantages and objects hereof, and are as follows:

FIG. 1 is the framework drawing of the conventional digital image sensor where the photodiode array using active pixel sensor cells in the CMOS process is taken as an example, and the R, G and B color array is arranged according to the human vision.

FIG. 2 is the illustrated drawing of cross section of the conventional color photodiode where the micro-lens in the upper part is added to enhance the photo-response.

FIG. 3 is the photo-responses of the red, green and blue color photodiodes, where the peak values of the photo-responses in these three photodiodes appear near red (650 nm), green (550 nm) and blue (450 nm). The most upper curve in the figure is the photo-response of the original photodiode without using a color filter.

FIG. 4 is the generation process of the photo-currents where the shaded region is the depletion region yielding the drift current, and the other regions generate the diffusion currents.

FIG. 5 is the relationship between the photon flux and the distance from the lighted surface showing exponent decay.

FIG. 6 is the relationship between the absorption lengths and the wavelengths λ, where FIG. 6(a) is the absorption lengths at the wavelength from 400 nm to 1000 nm and FIG. 6(b) is the scale-up view for the absorption lengths at short wavelengths.

FIG. 7 is the Nwell-Pepi-Psubstrate junction of the photodiode in TSMC 1P3M 0.5 um CMOS epitaxial process.

FIG. 8 is the simulation and measurement results of the photodiode in FIG. 7.

FIG. 9 is the relationship between the concentration of ion implantation and the number of minor carriers where the white spots at the upper part represent the minor carriers and at the lower part the minor carriers are black spots.

FIG. 10 is the relationship between the concentration of ion implantation and the mean lifetime of the minor carriers where the horizontal coordinate unit represents the power with a base of 10, and it could be found that the larger the concentration of ion implantation, the shorter the mean lifetime of the minor carriers.

FIG. 11 is the simulated photo-responses in three regions of the photodiode in FIG. 7.

FIG. 12 is the measured results of the photodiodes utilizing the TSMC 1P3M 0.5 um CMOS expitxial wafer process where the lines with black spots are the photo-responses of the photodiodes without color filters, and the lines with white spots are the photo-responses of the photodiodes with color filters. FIG. 12(a) is the photo-responses of the photodiodes with and without the red filters, FIG. 12(b) is the photo-responses of the photodiodes with and without the green filters and FIG. 12(b) is the photo-responses of the photodiodes with and without the blue filters.

FIG. 13 is the measured results of the color photodiodes.

FIG. 14 is the uniform distribution of the photo-response.

FIG. 15 is the integrated photo-responses of the photodiodes to approximate the photo-response of FIG. 14.

FIG. 16 is the photo-responses of the color photodiodes being linearly added here the gains of A1, A2, . . . , and An could be accomplished by adapting the areas of the photodiodes or the gains of the amplifier circuits.

FIG. 17 is the block diagram of adapting the areas of the photodiodes and the gains of the amplifier circuits where FIG. 17(a) shows the different photo sensing areas, FIG. 17(b) shows the different gains of the back-end amplifier circuits and FIG. 17(c) shows the adequate areas and gains being integrated to achieve the smooth response.

FIG. 18 is the structures of the photodiodes in TSMC 1P3M 0.5 um and TSMC 1P3M 0.6 um process.

FIG. 19 is the structures of the photodiodes with multiple PN junctions of this invention where the lighted surfaces in FIG. 19(a) and FIG. 19(b) are N-type and P-type semiconductors, respectively.

FIG. 20 is the photodiode with two PN junctions which are formed by the Pdiffusion-Nwell and Nwell-Psubstrate where the photodiode with said structure can be implemented by TSMC 1P3M 0.6 um process and TSMC 1P4M 0.35 um process.

FIG. 21 is the simulation result of the photodiode in FIG. 20 where the lines with the black and white spots are the photo-currents generated by the photodiode in junctions of Pdiffusion-Nwell and Nwell-Psubstrate, respectively.

FIG. 22 is the photodiode with shorting a PN junction which causes the electron-hole pairs being recombined again and again to make the junction current become zero such that these exist two kinds of shorting connections in this photodiode to yield two photo-responses as shown in FIG. 21.

FIG. 23 is the color photodiode with an adaptive structure provided by this invention where SW1, SW2, . . . and SWn are the switches which are used to generate different photo-responses.

FIG. 24 is the simulation results of the photo-responses of the photodiode with three PN junctions where the photo-responses generated by the first through the third PN junctions are shown from left to right.

FIG. 25 is the photo-responses of the Pwell-Pepi-Psubstrate photodiode fabricated by the TSMC 1P3M 0.5 um process under various reverse bias voltages where FIG. 25(b) is the scale-up view of the partial portion of the photo-response in FIG. 25(a), the highest curve being generated at the reverse bias voltage of 5V, the middle at 3V and the lowest at 0V.

FIG. 26 is the photo-responses of the depletion region of the Nwell-Pepi-Psubstrate photodiode fabricated by the TSMC 1P3M 0.5 um process under various reverse bias voltages where the highest curve is generated at the reverse bias voltage of 5V, the middle at 3V and the lowest at 0V.

FIG. 27 is the photo-responses of the Nwell-Pepi-Psubstrate photodiode fabricated by the TSMC 1P3M 0.5 um process under various reverse bias voltages; from the result it could be found that, when the reverse bias voltage changed from 0V to 5V, the curves of photo-responses almost are the same.

FIG. 28 is the photo-responses produced by summing photo-responses of two photodiodes at different photo-sensing areas where FIGS. 28(a), 28(b) and 28(c) are the summed photo-responses of two photodiodes fabricated by the TSMC 1P4M 0.35 um process, TSMC 1P3M 0.5 um process and TSMC 1P3M 0.6 um process, respectively.

FIG. 29 is the photo-responses produced by utilizing different shorting connections of the photodiodes where FIGS. 29(a), 29(b) and 29(c) are the photo-responses of the photodiodes fabricated by the TSMC 1P4M 0.35 um process, TSMC 1P3M 0.5 um process and TSMC 1P3M 0.6 um process, respectively.

FIG. 30 is the photodiode with three PN junctions.

FIG. 31 is the connection topologies of the photodiode in FIG. 30 generating red, green and blue where FIGS. 31(a), 31(b) and 31(c) are the connection topologies for generating blue, green and red, respectively.

FIG. 32 is the simulated photo-responses of the photodiode in FIG. 30 with the connection topologies in FIG. 31.

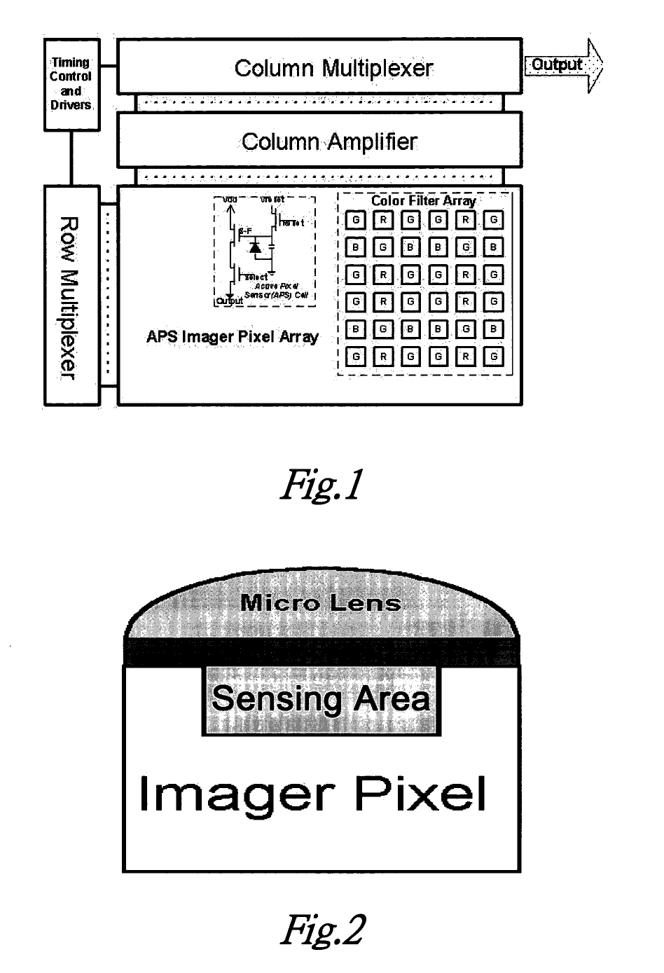

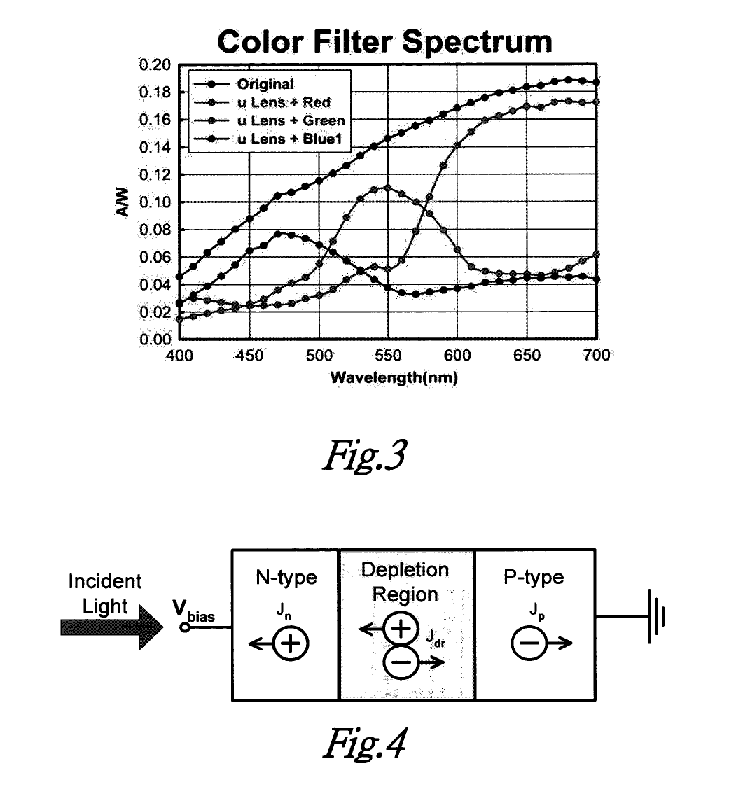

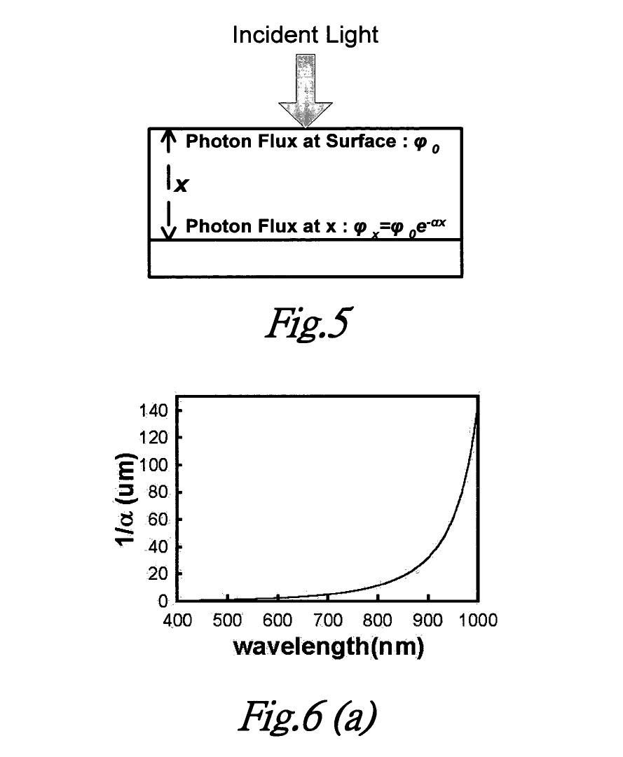

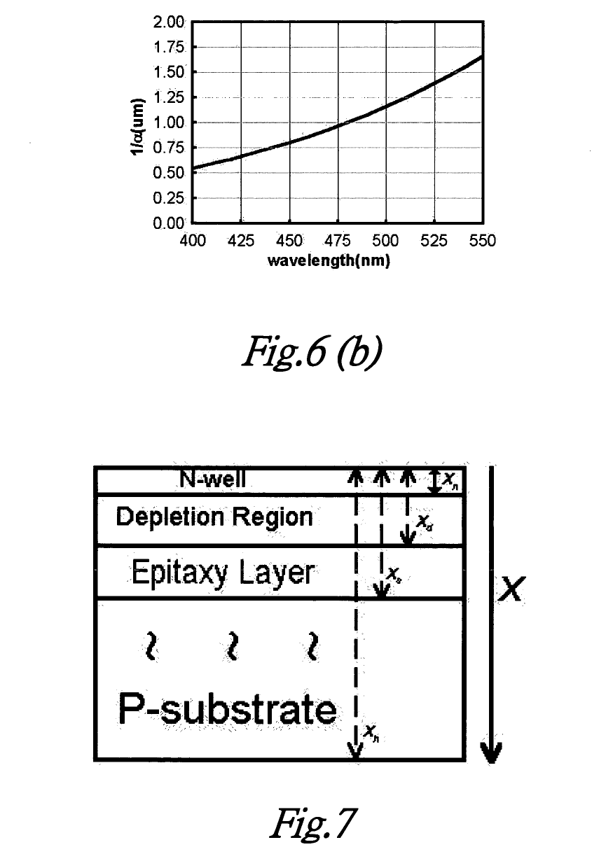

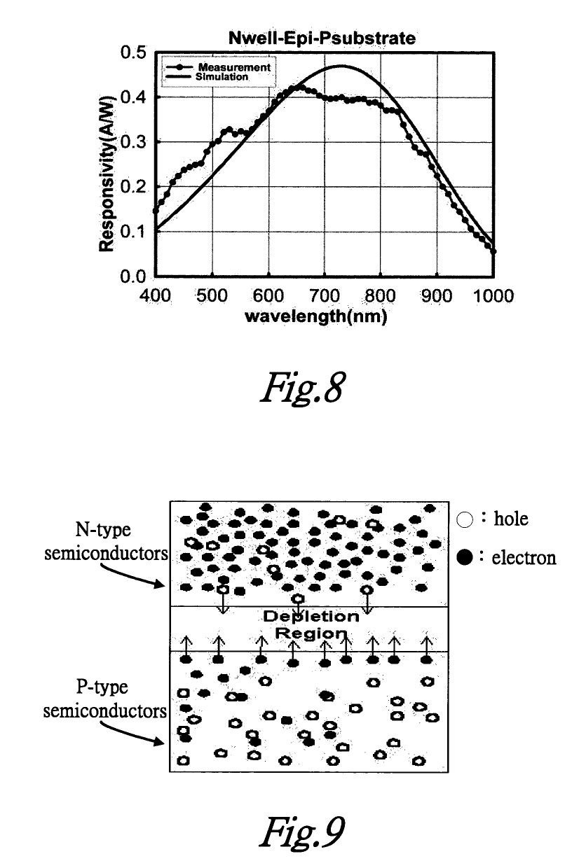

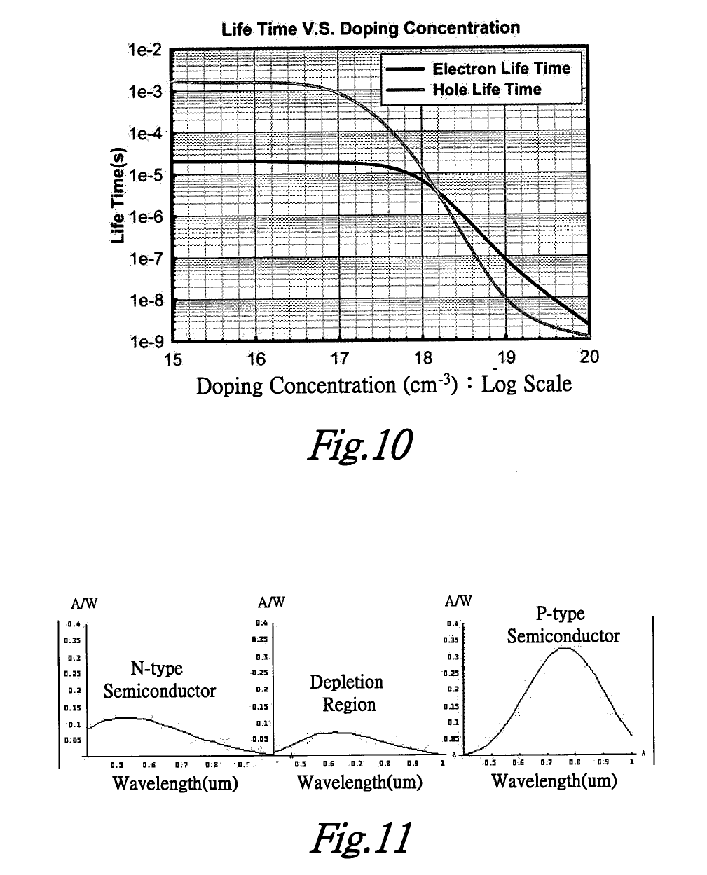

### DETAILED DESCRIPTION OF THE PREFERRED EMBODIMENT

The design methods and apparatuses of photodiodes with adaptive structures to achieve smooth or wavelength-selective responses of this invention are explored based on the following concepts.

1. Make the photo-response more uniform distribution by utilizing the way of signal summation, which is beneficial to simplify the design of the color filters and back-end color compensation circuits.

2. Disclose the optimized parameter values for the semiconductor process to achieve the uniform distribution of the photo-response and to obtain the maximum photo-response as well as the peak value at a specific wavelength.

3. Design the photodiode with multiple PN junctions to achieve multiple wavelength-selective responses, and this photodiode after an adequate layout design does not need the color filters to sense different colors.

Accordingly, it will be explained in detail with the following paragraphs aiming at the above-mentioned issues:

1. Method of Linear Summation

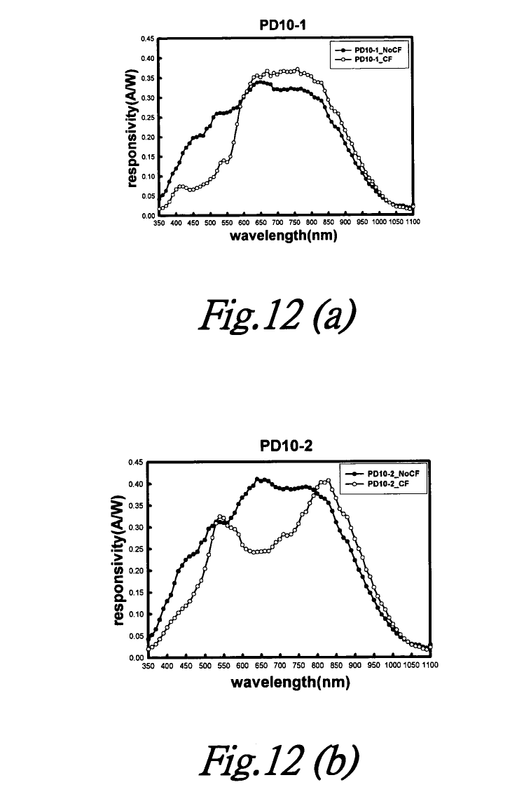

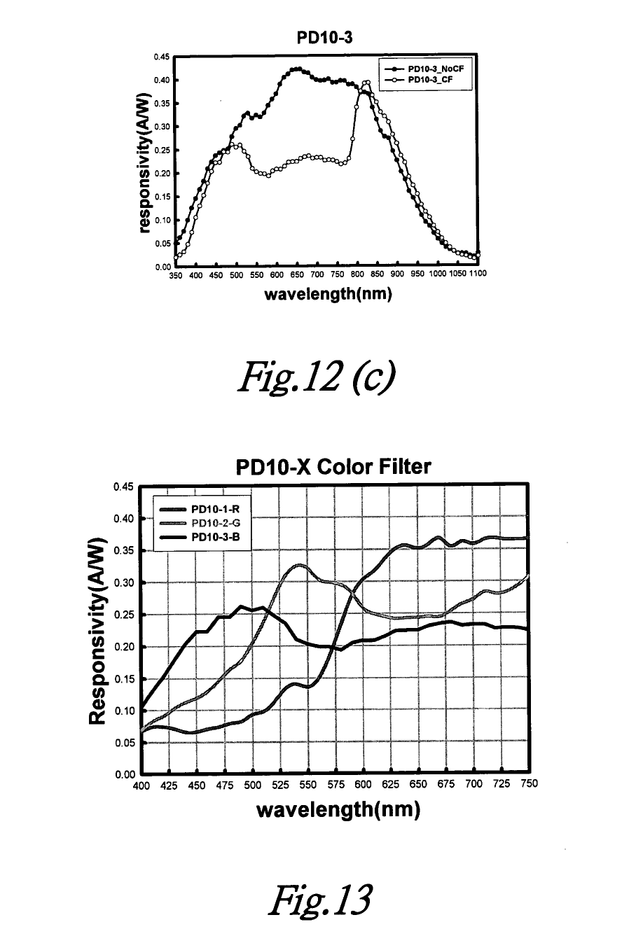

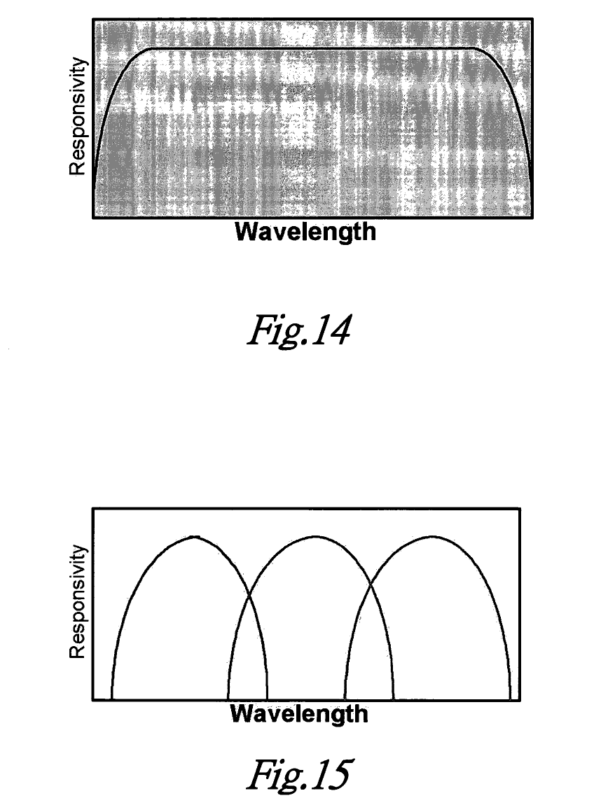

The reason why we propose this design method is to obtain the photo-response with a more curve. FIG. 12 shows the measured results of the photodiodes utilizing TSMC 1P3M 0.5 um CMOS epitaxial wafer process. FIG. 13 is the measured results of the photodiodes with red, green and blue filters. From FIG. 13 it is obviously seen that the magnitude of the photo-responses vary at various wavelength segments. Because of such reason, when we design the color image sensor, on one hand the impact of the color filter toward the original photodiode should be taken into account, and on the other hand of designing the back-end color compensation circuit, the photo-responses of the photodiodes with red, green and blue filters should be taken into consideration, which increases the degree of design difficulty. Thus this design method has been proposed to achieve the photo-response shown in FIG. 14 that can be formed by the photo-responses of multiple photodiodes, as shown in FIG. 15, with color filters at the same transmission rate.

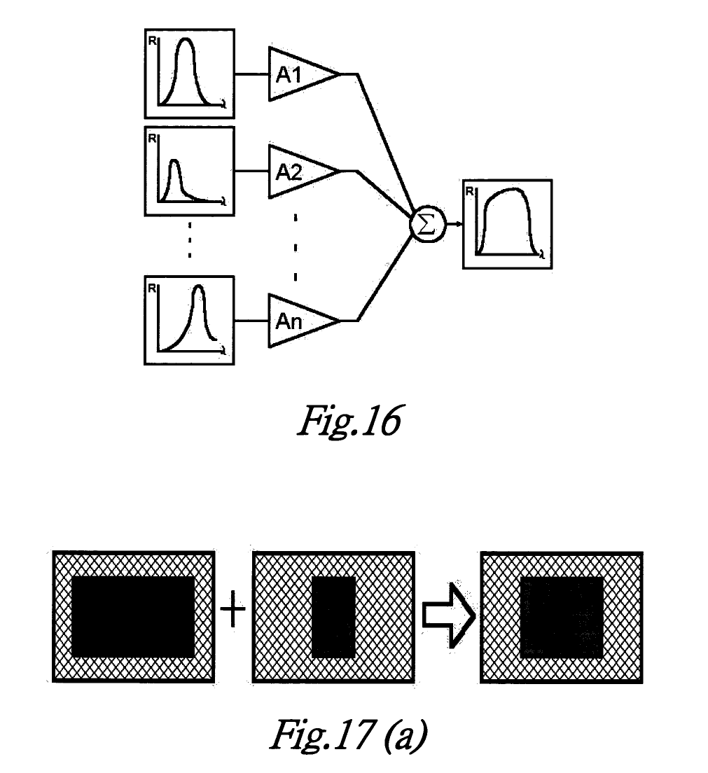

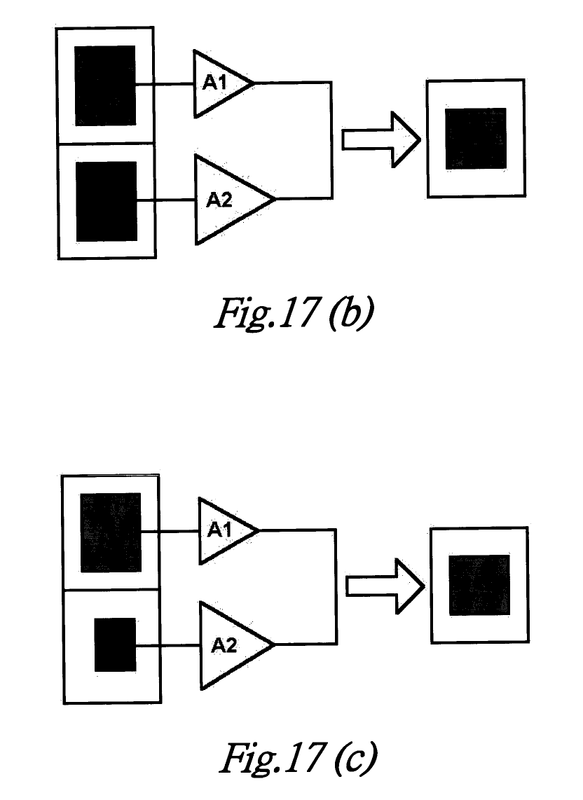

The approach of this invention as shown in FIG. 16 is to sum the photo-current signals of the photodiodes with various photo-responses, which means that it performs linear combination or addition by utilizing multiple photodiodes with various photo-responses so that the overall photo-response becomes smooth. Before summation of these photo-current signals, adequate gains should be made toward such photodiodes with various photo-responses. This invention proposes three ways of generating the photo-currents. The first one, as shown in FIG. 17(a), directly changes the area of the lighted region of the photodiode, since the value of the induced photo current signal is proportion to the lighted area. Hence the area alteration could achieve the purpose of adjusting the photo-response. The second way is illustrated in FIG. 17(b), which is achieved by utilizing the back-end amplification circuits to have different gains, that can result in adjusting the photo-responses. The third, which is the combination of the above-mentioned two ways, obtains the smooth photo-response by adequately determining the lighted areas of the photodiodes and the gains of back-end amplification circuits.

2. Methods of Determining the Optimized Values of the Process Parameters

There are many choices to determine the values of the process parameters for achieving the purpose of the maximum photo-response at a specific wavelength. However, since there still are some certain rules to follow due to the characteristics of these parameters, this invention try to find a set of optimized process parameters to achieve the required photo-response.

Before this, reasonable limitation for the ranges of the parameters used in the fabrication process is required. First, the ion doping concentration ranges form 1×10¹⁴ to 1×10²⁰(cm⁻³), of which the minimum concentration is confined by the process technology which still leaves the space for improvement in the future evolution of the process, and the maximum concentration is limited by the physical structure. Let's take the silicon material as an example, its atomic density being 5×10¹²(cm⁻³), which means that 1×10²² (cm⁻³) ionic doping concentration almost reaches its physical limitation. Next, the practical limitation of the thickness of a material layer should be taken into consideration. In general, the minimum thickness would be near 10 μm so that the layer could stand the pressure during fabrication. On the other hand, in considering the impact of the absorption coefficient, the thickness of a material layer could thus be within two to three times of the absorption length. For example, the threshold wavelength of the silicon substrate is about 1 μm. An incident light wavelength beyond such threshold could not emit the electron-hole pairs since its energy is smaller than the energy band of silicon. Hence the absorption length of the incident light with a wavelength of 1 μm is about 150 μm, and thus the thickness range for investigation is between 0.01 μm to 500 μm.

Next simulations of the photo-diode illustrated in FIG. 4 is performed, where we found that the larger the photo-response is the lower the concentration is. The lower ion doping concentration means the longer lifetime of the minor carriers so that it is preferred to make the concentration of doping as low as possible where the larger photo-response can be obtained. The thickness has to be investigated from two parts: the first one determining the thickness of the lighted layer and the second determining the thickness of the unlighted layer. It was founded that all these peak values appear when the thickness of the lighted layer is close to the width of the depletion region. The reason why makes such phenomena could be explained from the carrier absorption rate. The process from that the P-type and N-type regions are excited by the incident light to generate the electron-hole pairs to that the electron-hole pairs are absorbed by the depletion region is to form the photo current. Since the generation rate of carriers has logarithmic decay, only at the edge of the depletion region the generated electron-hole pairs can efficiently yield the photo currents. However, due to a built-in electrical field within the depletion region, the absorption rate of the electron-hole pairs within this region could reach 100%. The electron-hole pairs inside the depletion region could completely form the photo-current. Based on such reason, if we could extend the width of the depletion region to the lighted surface, then the electron-hole pairs generated by the lighted layer could be completely absorbed for generating the photo-current.

The second part is to determine the thickness of the unlighted layer. The more thick the thickness of the unlighted layer is, the higher the photo-response is, which also involves the issue of carrier absorption. What is difference between the lighted and unlighted layers? At the lighted layer, when the depletion region extends to cover this layer, the usage ratio of the carriers is maximal. However, at the unlighted layer, when its thickness is increased, its absorption rate toward carriers also becomes larger because of more carriers being absorbed. That is to say, on the choice of the thickness of the unlighted layer, except for the thickness being selected larger than that of the depletion region, the carrier absorption effect is considered so that the thickness of this layer must be widen to achieve a larger photo-response. One point should be mentioned here, that is the phenomena of the photo-response not obviously increasing after the thickness of the unlighted layer reaches two to three times of the diffusion length. This is because it is affected by the absorption length.

According to the above-mentioned analyses of the physical phenomena, there are several conclusions summarized below on increasing the photo-response.

(1) The carriers from the lighted layer are to be absorbed completely, if possible, before reaching the depletion region, so the thickness of the lighted layer is designed, that can be filled by the depletion region.

(2) As thick as possible for the unlighted layer beyond the depletion region, at least it should be thicker than the thickness of the depletion region to increase the number of carriers being absorbed.

(3) Decrease the doping concentration if possible.

List below are several main parameters which affect the photo-response, as represented by Eq. (2.4). This equation is the function of the photo-response, where WU represents the depth from the lighted surface to the depletion region, WD represents the thickness of the unlighted semiconductor material, and n and p represent the doping concentrations of electrons and holes, respectively. If we want to obtain the maximum photo-response, Eq. (2.5) represents how to decide the values of the parameters. That is to say, the width of WU should be as near the width of the depletion region as possible, the width of WD should be as large as possible, and for the doping concentration it should be as low as possible to design a photodiode. If the design criterion is followed, the maximum photo-response would be acquired.

R=f(WU, WD, n, P)_{V=0} (2.4)

R_{Max}=f(WU<Depletion, WD→Max, n→Min, p→Min)_{V=0} (2.5)

If the detailed mathematical equations are explored based on the photodiode in FIG. 4, then the photo currents could be interpreted by the following three equations:

$$\begin{matrix}\frac{q {φ}_{0} α {e}^{- TN α} {L}_{p} ( {L}_{p} ( α {D}_{p} - {S}_{p} ) Cos h [ \frac{TN}{{L}_{p}} ] + ( - {D}_{p} + α {L}_{P}^{2} {S}_{p} ) Sin h [ \frac{TN}{{L}_{p}} ] + {e}^{TN α} {L}_{p} ( α {D}_{p} + {S}_{p} ) )}{} & ( 2.6 ) \\ \frac{q {φ}_{0} α {e}^{- ( WN + WP + DRP ) α} {D}_{n} ( {τ}_{n} {e}^{WP α} ( {L}_{n} ( α {D}_{n} - \text{?} - {e}^{DRP α} {L}_{n} ( α {L}_{n}^{2} - {S}_{n} {τ}_{n} ) )}{{L}_{n} ( - 1 + {α}^{2} {L}_{n}^{2} ) ( {D}_{n} Cos h [ \frac{TP}{{L}_{n}} ] + {L}_{n} {S}_{n} Sin h [ \frac{TP}{{L}_{n}} ] )} \\ \text{?} \text{indicates text missing or illegible when filed} & ( 2.7 )\end{matrix}$$

qφ₀(e^{-α(DRN+WN)}−e^{-α(DRP+WN)}) (2.8)

Eq. (2.6) represents the photo-current induced from the N-typed region, Eq. (2.7) represents the photo-current induced from the P-typed region, and Eq. (2.8) represents the current in the depletion region where Lp and Ln represents the diffusion lengths of holes in the N-typed region and electrons in the P-type region, respectively, of which values could be acquired by taking the square root of the product of the diffusion coefficient of the electrons (holes) and their mean lifetime. TN represents the width of the N-typed region (WN) minus the width of the depletion region in the N-typed region (DRN) whereas TP represents the width of the P-typed region (WP) minus the width of the depletion region in the P-typed region (DRP).

From Eq. (2.6), it could find the impact of the widths of the depletion region and the lighted semiconductor toward the photo-response. When the width of the depletion region is close to the thickness of the lighted semiconductor, the maximum value of the photo-response could be obtained by using the adequate doping concentration, which could be understood from the relationship between the diffusion length and the absorption length. If it is represented by the mathematical equation, the relationship is illustrated by the following mathematical expression and analysis.

First make the differential operation toward the Eq. (2.4) of the photo-response by using TN, and then two maximum values would occur when TN equals 0 or α equals Lp. On the other hand, if we perform the differential operation toward TP, the equation of the photo-response become a positive formula. That is to say, the photo-response increases with TP. While TP is not considered, two conditions can be applied to make conclusion on the design method regarding to the single PN junction:

1) TN=0 (i.e., WN=DRN, and

(2) α=Lp.

The above first condition could be used in the equation of the photo-response to derive the following equation.

$$WN = \sqrt{\frac{2 {∈}_{si} ( {φ}_{bi} + {V}_{bias} )}{q} ( \frac{1}{n} + \frac{1}{p} )} \times \frac{p}{n + p} \qquad ( 2.9 )$$

The second condition could be utilized in the equation of the photo-response to derive Eq. (2.10) with understanding the relationship between the doping concentration and the maximum photo-response under a certain wavelength. Since α is the function of wavelengths, and Lp is the function of concentration, the new function of Eq. (2.10) is thus obtained, which is the relationship between wavelengths and concentration, to be the design criterion.

$${10}^{( 13.213 - 36.7985 λ + 48.1893 {λ}^{2} - 22.7562 {λ}^{3} )} = \sqrt{1.083 \times {10}^{18} \times \frac{6.992 \times {10}^{17}}{n + 2.990 \times {10}^{17}}} \times \sqrt{8.527 \times {10}^{- 10} \times \frac{2.9 \times {10}^{19}}{n + 1.999 \times {10}^{18}}} \qquad ( 2.10 )$$

In the following, we should discuss about the method of obtaining the peak photo-response at a specific wavelength. First, equations of Eqs. (2.6), (2.7) and (2.8) are summed up, and then the photo-current equation of the photo-response is obtained. Next take out the parameters of α and φ0, and replace them with the functions of wavelengths where α could be replaced by Eq. (2.3) and φ0 could be replaced by Eq. (2.1). Next the other parameters should be replaced with the functions of concentration by utilizing Eqs. (2.9) and (2.10). After two replacements, the photo-current equation could be interpreted as a function of wavelength and concentration. Now it is assumed that the peak value of the photo-response appear at λ1. The differential operation toward λ is performed in Eq. (2.11) to obtain Eq. (2.12), next λ is replaced by λ1 in Eq. (2.13), and then the differential equation is solved to make itself equal to zero. The whole process could be illustrated in the following three equations.

R=f(λ, n, p, V) (2.11)

$$\frac{\partial R}{\partial λ} = {f}^{′} ( λ , n , p , V ) \qquad ( 2.12 )$$

f′(λ, n, p, V)_{λ=λ}_{₁}=0 (2.13)

As mentioned above by utilizing Eqs. (2.11), (2.12) and (2.13), the values of the process parameters for yielding the peak photo-response can thus be adequately determined.

3. Design Method of the Photodiodes without Color Filters

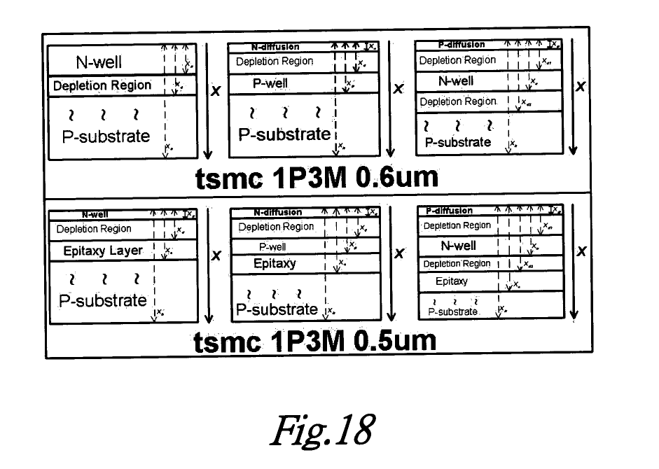

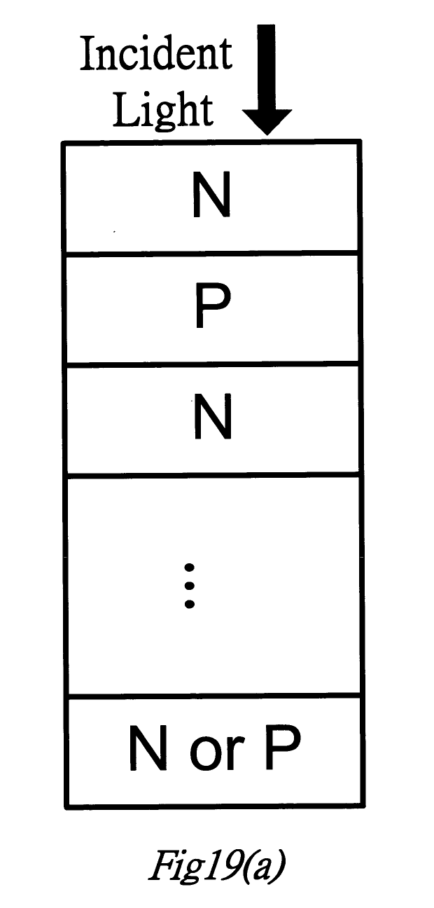

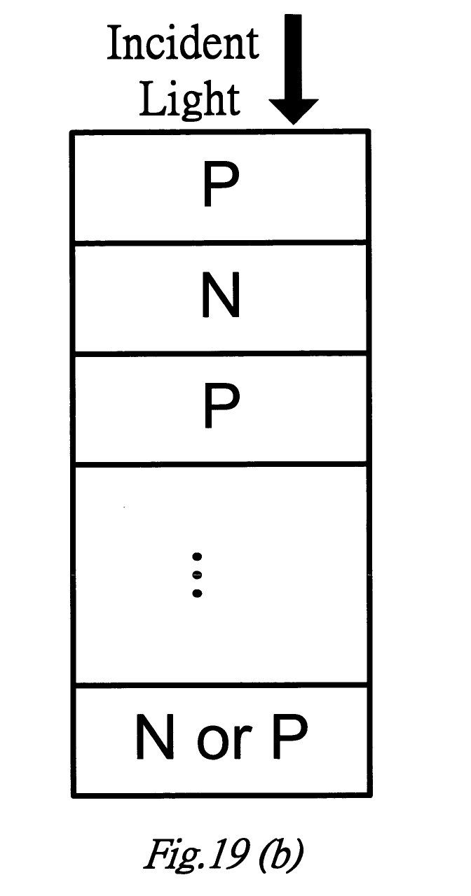

The number of PN junctions formed by the material layers from the commercial process is very small. FIG. 18 shows the material layers of the TSMC two processes for designing photodiodes. From such figure, the structure with two PN junctions is the P+_Nwell_Psubstrate photodiode. The layers of the PN junction with different thickness generate different photo-response. Hence, this invention proposes the photodiode with multiple PN junctions as shown in FIG. 19 to provide multiple sets of photo-responses for selection.

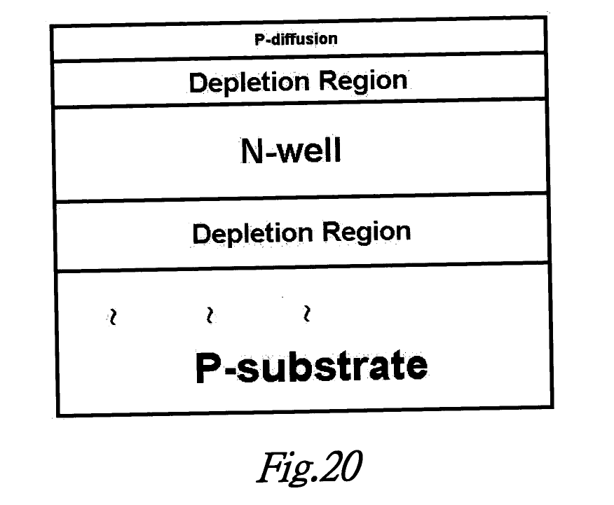

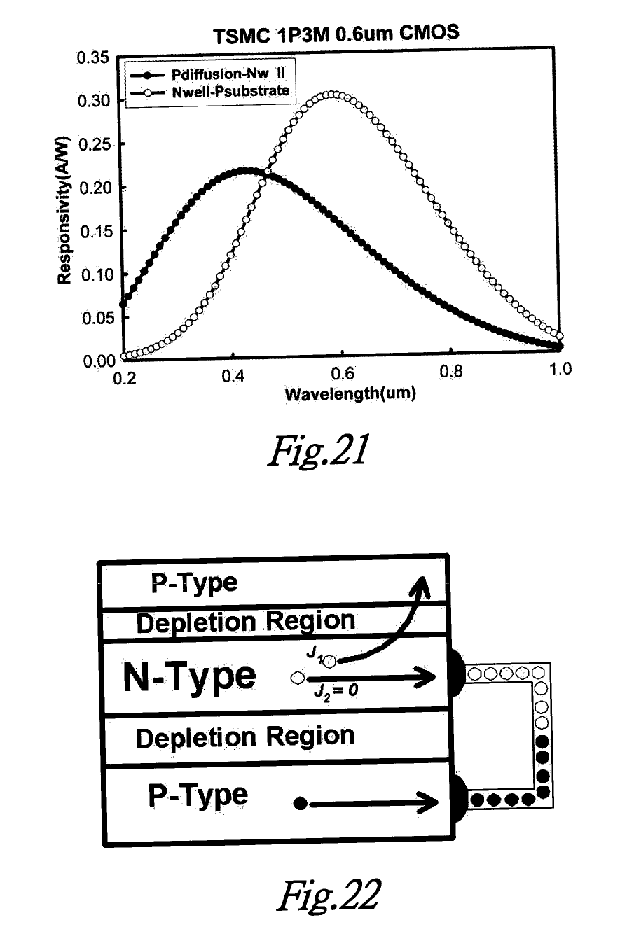

Next we consider the way of how to separate and take out one from multiple sets of the photo-response. The basic principle of this invention could be illustrated first from the Pdiffusion-Nwell-Psubstrate structure using the TSMC 1P3M 0.6 um CMOS process, as shown in FIG. 20, with two PN junctions which are Pdiffusion-Nwell and Nwell-Psubstrate. The photodiode with this Pdiffusion-Nwell-Psubstrate structure could provide two sets of photo-responses. The total photo-response of the photodiode is the sum of the photo-currents contributed by these two PN. The photodiode with different depths of the PN junctions and different concentration of the ion doping in each layer yields different photo-responses. FIG. 21 is the simulation result by utilizing the Pdiffusion-Nwell-Psubstrate photodiode. From that simulation result, it could be seen that the photodiode has two sets of photo-responses due to its two PN junctions. Now if we want to take out one of these two sets of photo-responses, the scheme we use is to short the PN junction that we do not want. FIG. 22 shows the photodiode with shorting a PN junction. Once the PN junction is to be shorted, the electron-hole pairs generated within this PN junction are recombined, and thereby the photo-current contributed by such junction would be erased. That is to say, if we short Pdiffusiion and Nwell layers, the photo-response having a peak value at a short wavelength of such layers would be disappear. On the contrary, if we short the Nwell and Psubstrate layers, the photo-response having a peak value at a long wavelength would be erased where the photodiode just has only the photo-response of the Pdiffusion-Nwell junction.

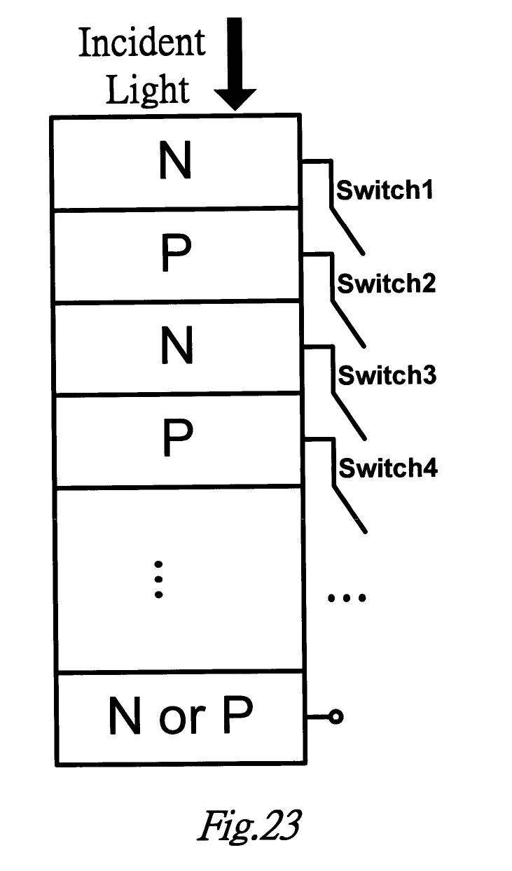

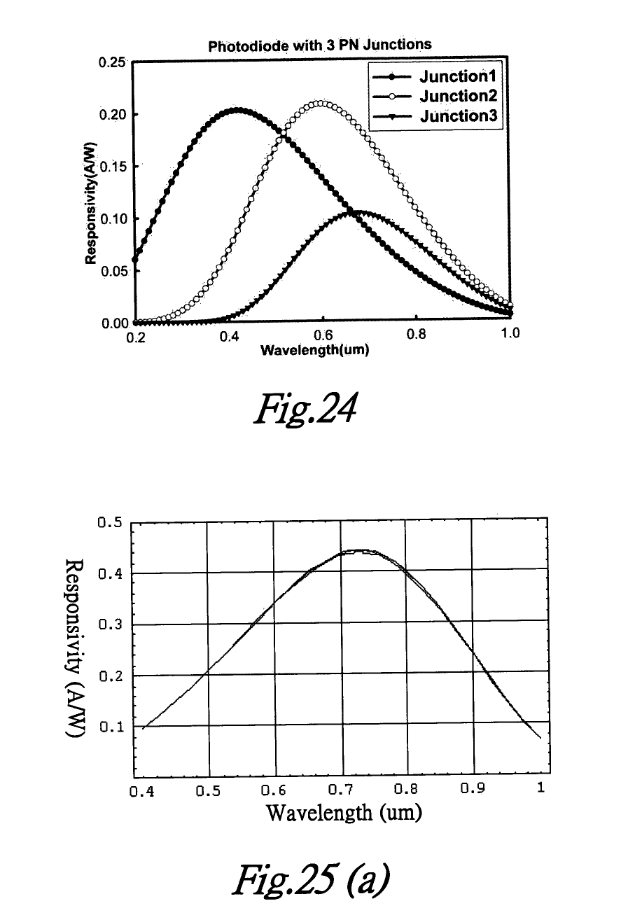

Utilizing such kind of idea, the following structure is proposed to design the photodiode with yielding multiple photo-responses. As shown in FIG. 23, if the process could provide multiple PN junctions with various depths, each junction has a different photo-response. Next we design switches which could short PN junctions. Utilizing each switch to determine the usage of each PN junction or not, this invention could thus efficiently obtain the required photo-response under adaptive control. FIG. 24 shows the simulation result of the photodiode with three PN junctions.

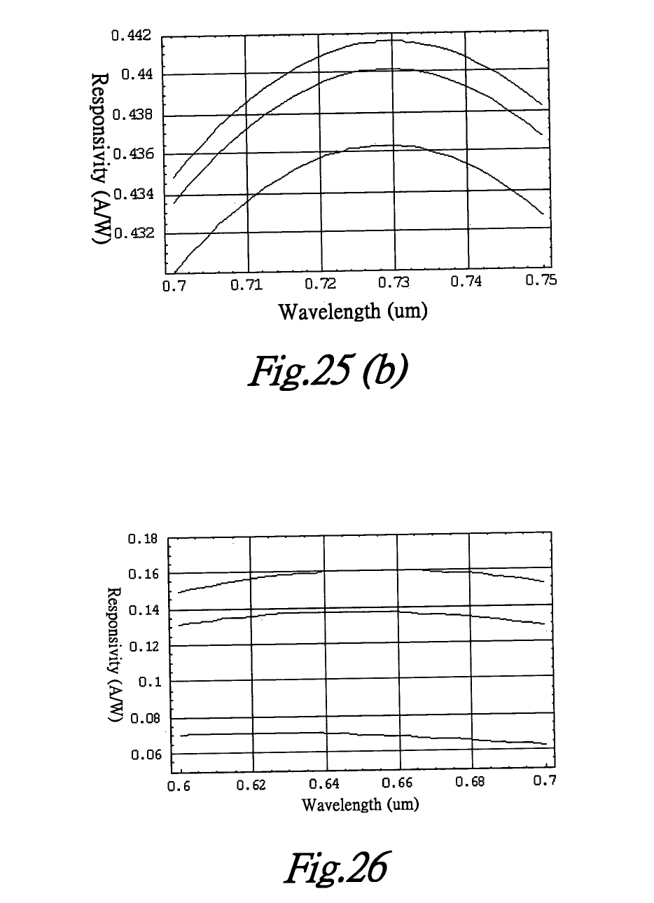

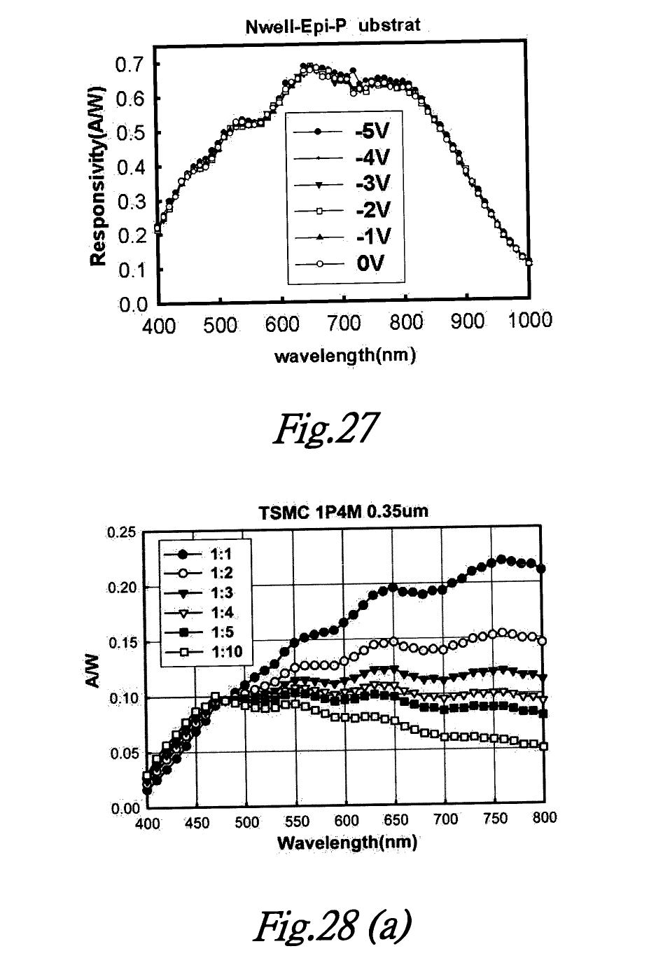

According to the analysis results of the previous paragraphs, it could be found that if we try to efficiently obtain the different photo-responses in a photodiode, we could achieve them by altering the amount of the induced currents from the N-type semiconductor, the depletion region and P-typed semiconductor. To achieve such purpose, someone proposed to utilize the way of controlling the reverse bias voltage, of which basic principle is to alter the width of the depletion region by using the reverse bias voltage. Once the width of the depletion region is altered, the boundary values of the N-typed and P-typed semiconductors are altered also, which influence the overall photo-response to achieve the purpose of shifting the peak value of the photo-response. However, as for the practical implementation which could be seen from the simulation result as shown in FIG. 25, when the reverse bias voltage is between 0 and 5V, the overall photo-response is almost unaltered at different reverse bias voltages. The reason can be observed from FIG. 26. When the reverse bias voltage is changed from 0V to 5V, the change in the depletion region is less than 1 μm, which makes the overall photo-response be dominated by the induced current from the P-typed semiconductor. As shown in FIG. 27, the measurement result of the Nwell-Epi-Psubstrate photodiode illustrates that the effect of utilizing the reverse bias voltage to control the photo-response is not obvious.

4. Explanation of the Preferred Embodiment:

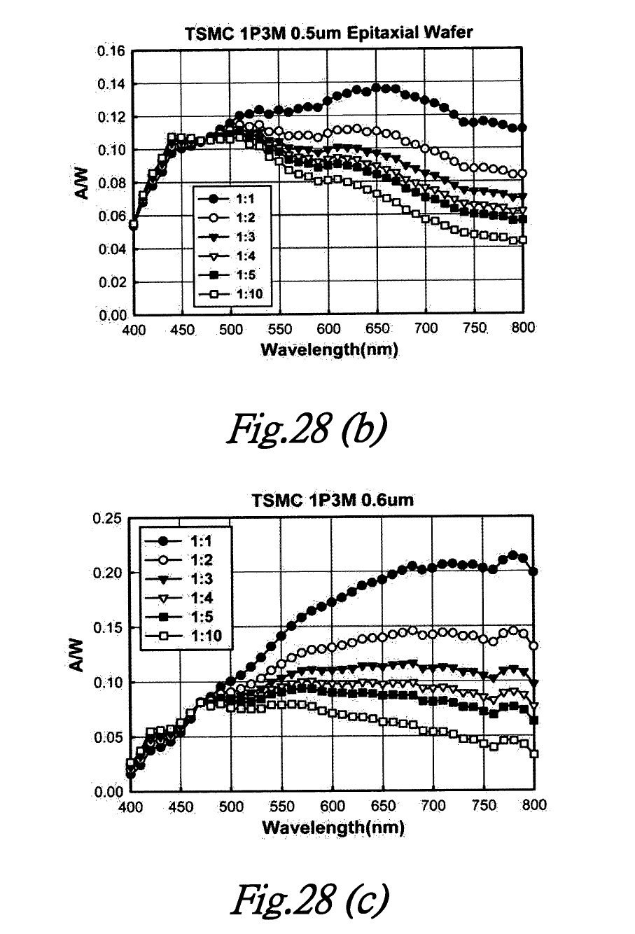

FIG. 28 shows the overall photo-response by using the signal summation of the two photodiodes with different photo-responses under various areas. We can find that under a specific condition of the area ratio, a set of photo-response with the most smooth curve can be achieved. The experiments discovered from FIGS. 28(a), 28(b) and 28(c) demonstrate the practicability of linear summation. This invention adds the signals of several photodiodes with different photo-responses and with different photo-sensitive areas to acquire the demanded photo-response.

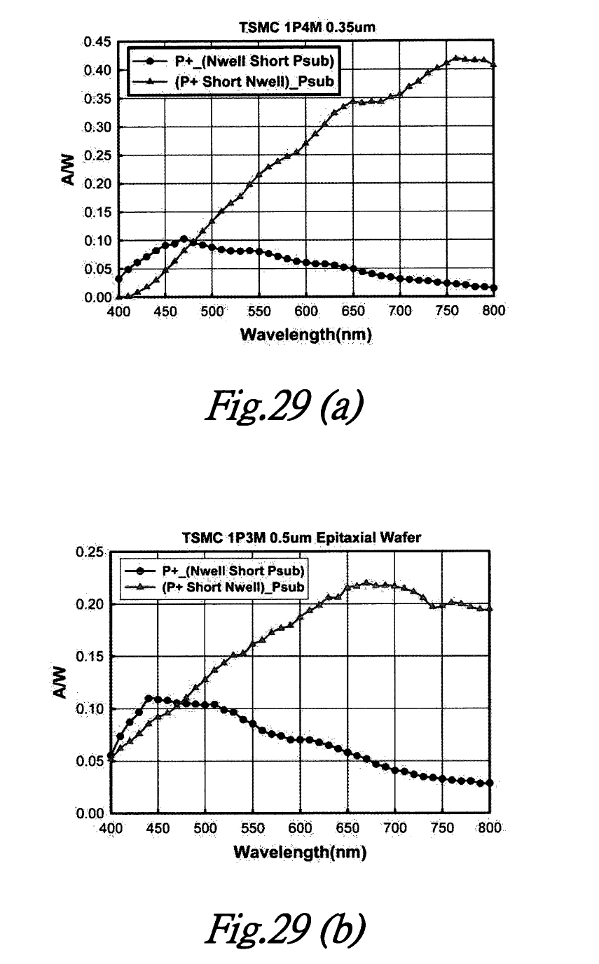

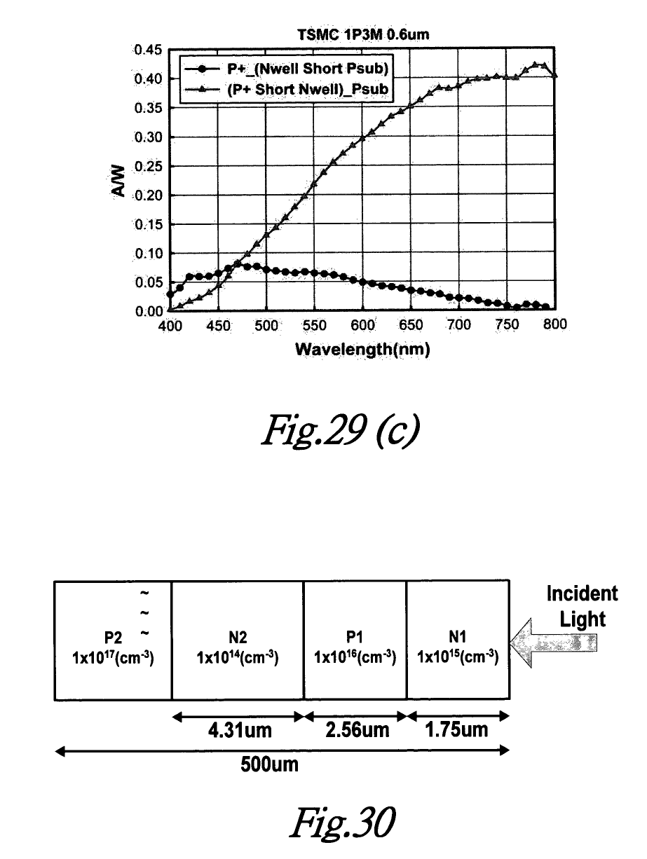

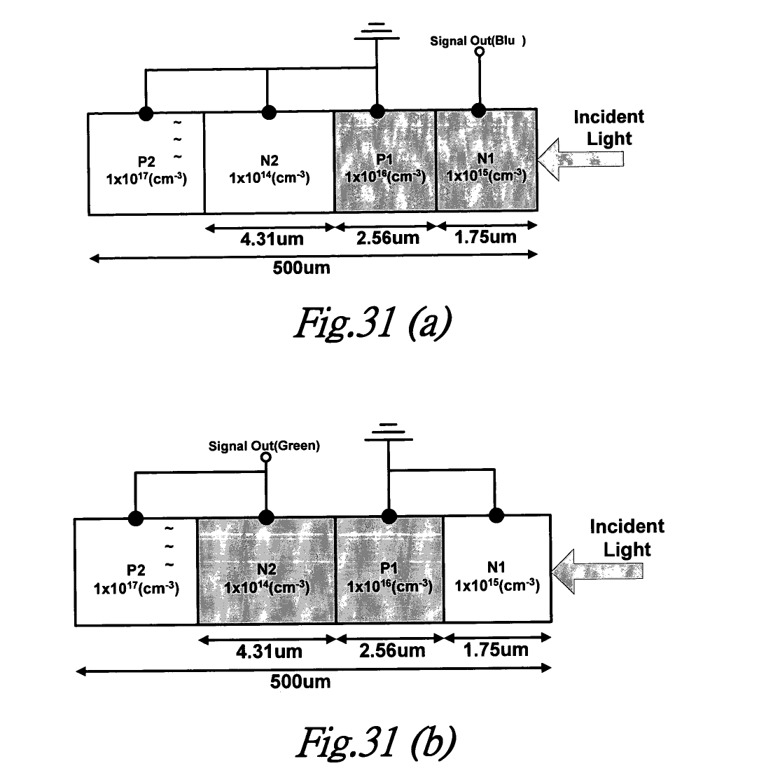

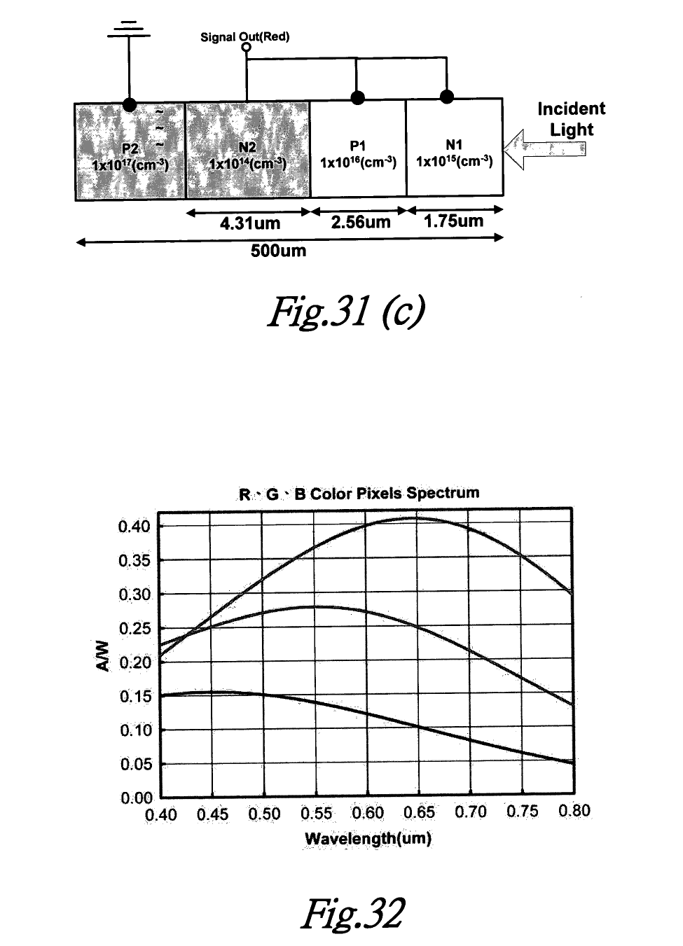

FIG. 29 is the measured result of the Pdiffusion-Nwell-Psubstrate photodiode fabricated by the TSMC. The peak value of the photo-response is moved to the position at a short wavelength when the Nwell and Psubstrate are shorted or connected together through the conducting metal. On the other hand, when the Pdiffusion and Nwell are shorted together, the peak value of the photo-response is moved to the position at a long wavelength. From such figure we could see clearly that, in the same photodiode, the peak value of the photo-response can be shifted by shorting some semiconductor layers. Besides, we make simulations utilizing the photodiode with three PN junctions, of which concentration and thickness in each layer are depicted in FIG. 30. In chip layout, let's take switches using the CMOS transistors to short three different junctions, as shown in FIG. 31, so that we could obtain red, green and blue photo-responses in a single photodiode. FIG. 32 is the simulation result of this photodiode with three PN junctions.

The photodiode with multiple PN junctions is designed to sense multiple colors by shorting some PN junctions. In other words, the photodiode with adaptive PN junctions can select the peak value of the photo-response at a specific wavelength. Utilizing such approach, we could fabricate the photodiode with sensing multiple colors without using color filters when the adequate values of the process parameters are used.

Characteristics and Effects:

The design methods and apparatuses of photodiodes with adaptive structures to achieve smooth and wavelength-selective photo-responses provided by this invention have the following advantages in comparison of the other conventional methods and devices.

1. This invention utilizes the photodiodes with different photo-responses and different photo-sensing areas or connects the photodiodes to the back-end amplifiers with different gains. Next, linear addition is performed toward the photo-responses from these photodiodes, and then a set of curve with a large value at each wavelength is obtained which is also smooth. The object of this invention is to improve the non-uniform distribution of the photo-response of the photodiode in wavelengths of visible light. In addition, it also aids to simply the design of the back-end color compensation circuits.

2. This invention concludes some schemes of determining the values of the process parameters. These schemes can help to make a good use of physical characteristics of the photodiode to increase the photo-response of the photodiode and to yield the peak value of the photo-response at a specific wavelength.

3. This invention explores the feasibility of the color photodiodes without color filters and provides a layout scheme to adapt the photo-response of the photodiode. Since the PN junctions with different depths generates the photo-responses with peak values at different wavelengths, by utilizing such principles, the photodiode with multiple PN junctions can have multiple photo-responses. Next we make switches in a photodiode to select a specific photo-response and thus this photodiode can adaptively sense different colors.

Many changes and modifications in the above described embodiment of the invention can, of course, be carried out without departing from the scope thereof. Accordingly, to promote the progress in science and the useful arts, the invention is disclosed and intended to be limited only by the scope of the appended claims.

What is claimed is:

1. Design methods and apparatuses of photodiodes with adaptive structures to achieve smooth and wavelength-selective photo-responses comprises the following:
(1) utilizing the way of signal summation to yield the uniform distribution of the photo-response to be beneficial to the simplification on the design of the back-end compensation circuits,
(2) determining the adequate values of the process parameters of the semiconductors to achieve the maximum photo-response as well as to acquire the photo-response with the peak value at a specific wavelength, and
(3) designing the photodiode with multiple PN junctions to provide multiple photo-responses without using color filters in cooperation with the adequate layout design of this photodiode.

2. The design methods and apparatuses of photodiodes with adaptive structures to achieve smooth and wavelength-selective photo-responses is as mentioned in claim 1, where the method (1) utilizes the way of signal summation to generate the uniform distribution of the photo-response of the photodiode to be beneficial to the simplification of design on the back-end color compensation circuits and this method (1) is described as follows:
(a) it is designed directly from the photo-sensing area of the photodiode-and by performing the layout design to construct photo-sensing areas, the area size is in reverse proportional to the photo-response of the photodiode and utilizing adequate photo-sensing areas of multiple photodiodes to obtain multiple photo-responses, these photo-responses are summed together to yield the smooth distribution of the total photo-response in all sensed wavelengths;
(b) it is explored by using the back-end amplifiers where in order to make the photo-sensing areas of photodiodes be the same size each photodiode is connected to an amplifier, such design conforms the specification requirements that each gain of these amplifiers is in reverse proportional to the photo-responses where multiple photodiodes produce the photo-response signals, after being enlarged through the amplifiers, that are added to generate the smooth distribution of the total photo-response;
(c) by means of the schemes of (a) and (b), the size of the photo-sensing area and the gain of the back-end amplifier are to be calculated and determined such that the gain ratios of multiple photodiodes are the reciprocal of the corresponding size ratios to obtain the smooth distribution of the total photo-response.

3. The design methods and apparatuses are mentioned in claim 1 where the method (2) is to determine the optimized values of the process parameters of the semiconductors for smooth and wavelength-selective responses of the photodiodes comprises the following schemes:
(a) determine the value of the process parameters to obtain the maximum photo-responses where the photo-response can be represented by Eq. (3.1) and the list below are some parameters which are the major parameters that affect the photo-response, where WU represents the width from the lighted surface to the depletion region, WD represents the thickness of the unlighted semiconductor, and n and p represent the electron and hole doping concentrations, respectively: and if we want to obtain the maximum photo-response, Eq. (3.2) represents how to decide the values of the parameters and that is to say, the width of WU should be as near the width of the depletion region as possible, and the width of WD should be as wide as possible, whereas the doping concentrations of n and p should be as low as possible in designing the photodiode and if we conforms such design criterion, the photo-response with maximum value is obtained:
R=f(WU, WD, n, p)_{V=0} (3.1)
Rₘₐₓ=f(WU→Depletion, WD→Max, n→Min, p→Min)_{V=0} (3.2);
(b) determine the values of the process parameters to obtain the peak value of the photo-response at a specific wavelength where from Eq. (3.1) of the photo-response, take out the parameters of α and φ0, and replace them with the functions of wavelengths, next the other parameters are replaced with the functions of concentration where then after two replacements, we re-write the original equation of the photo-response to become the equation with only two variables of wavelength and concentration and if we want the peak value of the photo-response appearing at λ1 where first we must make the differential operation toward λ of this equation, next replace λ with λ1, and then solve such equation to make it equal to zero and the whole process could be explained as the following equations
R=f(λ, n, p, V) (3.3)
$$\frac{\partial R}{\partial λ} = {f}^{′} ( λ , n , p , V ) \qquad ( 3.4 )$$
f′(λ, n, p, V)_{λ=λ}_{₁}=0 (3.5).

4. The design methods and apparatuses are mentioned in claim 1, where the method (3) of designing the color photodiodes without color filters is proposed by using the photodiode with multiple PN junctions and multiple switches to generate multiple photo-responses for sensing multiple colors where first the photodiode is developed with multiple PN junctions to provide enough sets of photo-responses as well as to make more variations for the photo-responses and since the overall photo-responses for a photodiode is the summation of the photo-responses from all PN junctions, the proposed method is to separate and take out one from multiple sets of photo-responses by shorting the undesired PN junctions where the electron-hole pairs in the shorted junctions are to be generated and recombined again and again where the photo-currents contributed by such shorted junctions would be erased and where the other PN junctions without shorting can accumulate their photo-responses to generate the total photo-responses as demand and regarding to switches for the shorting operations, the layout of connecting each PN junction with a switch is designed and when the P and N layers are connected by using a conducting material, this PN junction becomes the shorting status and thus does not generate the photo-current and at such condition, the switch for this can be viewed as the “close” status where on the other hand, when the P and N layers are not connected by using a conducting material, this PN junction is the opening status and thereby yields the photo-current and the switch for this PN junction at such condition can be treated as the “open” state and by using the switches to determine which ones of multiple PN junctions are used, the unshorted PN junctions can generate the required total photo-responses to interpret a specific color and the photodiode with multiple PN junctions and multiple switches can sense multiple colors at different switching conditions.
